(19) United States
(12) Patent Application Publication
(10) Pub. No.: US 2016/0379384 A1
(43) Pub. Date: Dec. 29, 2016

(54) CHINESE CHARACTER INFORMATION RECORDING METHOD

(71) Applicant: Guangsheng LIN, Guangzhou, Guangdong (CN)

(72) Inventor: Guangsheng LIN, Guangzhou (CN)

(21) Appl. No.: 15/037,326

(22) PCT Filed: Dec. 18, 2013
(86) PCT No.: PCT/CN2013/089901

§ 371 Date: May 26, 2016

(30) Foreign Application Priority Data
Feb. 12, 2013 (CN) PCT/CN2013/071600

(51) Int. Cl. G06T 11/20; G09B 5/12; G09B 11/00; G09B 19/06; G06F 3/01; G06K 9/00

(52) U.S. Cl. CPC G06T 11/20; G06F 3/018; G06K 9/00402; G09B 11/00; G09B 19/06; G09B 5/125

(57) ABSTRACT

The present invention provides a Chinese character information recording method and a Chinese character stroke order recognition figure in an information recording method. A Chinese character structure is split into several parts step by step according to a simplicity rule in the Chinese character information recording method, and the several parts are sequenced, so as to recognize an approximate stroke order of the Chinese character structure. Similarly, approximate stroke orders of most Chinese characters can be recognized. With reference to a special situation table of a Chinese character stroke order, a step of recognizing a stroke of a Chinese character, and a step of recording a Chinese character by using an information recording tool according to a stroke order, most Chinese characters can be recorded successfully, thereby helping a beginner of the Chinese character to shorten time for successfully recording a Chinese character. Approximate stroke orders of most Chinese characters can be recognized simply by using the Chinese character stroke order recognition figure.

### CROSS REFERENCE TO RELATED APPLICATIONS

This application is a national application of PCT/CN2013/089901, filed on Dec. 18, 2013. The contents of PCT/CN2013/089901 are hereby incorporated by reference herein.

### FIELD OF THE INVENTION

### Technical Field

The present application relates to an information recording method, and more particularly, to a Chinese character information recording method which records Chinese characters by using an information recording appliance and which belongs to the IPC: G11B; and a diagram which recognizes Chinese character stroke orders and which belongs to the IPC: G09B 29/00.

### BACKGROUND OF THE INVENTION

### Background Art

Information recording is the foundation of the social civilization. In order to realize the information recording under different conditions or improve the efficiency of information recording under the same conditions (for example, the information recording under the water, the information recording under the condition of losing gravity), has produced a large number of information recording appliances, carriers and methods which have been mentioned in the Table of International Patent Classification.

The present application is an improved invention that has improved a basic step of the existing Chinese character information recording technology.

Englishman Tom has got his Tablet computer. He had never contacted with Chinese characters. If he wants to record Chinese characters smoothly on his Tablet computer, he needs to go through such process: a step for recognizing Chinese character strokes, a step for recognizing Chinese character stroke orders, and a step for recording Chinese characters according to Chinese character stroke orders by using his Tablet computer. (Using a Tablet computer or other information recording appliances include their operation application process.)

The second step (the step for recognizing Chinese character stroke orders) is a tedious and lengthy step. (In general, a Chinese character is composed of two or more Chinese character structures; a Chinese character structure is composed of two or more subordinate Chinese character structures; to the last, a Chinese character structure is composed of several strokes; so a Chinese character is composed of several strokes. Every Chinese character is equivalent to a graphic which is composed of several strokes, in order to record Chinese characters smoothly, have taken a method which has set down the order of every stroke of every Chinese character. This is the Chinese character stroke order method. “Stroke order” is “Chinese character stroke order” for short.) At present, after having learned Chinese for 9 years (including Elementary School and High School), China's domestic students can record 7,000 commonly-used Chinese characters according to the correct stroke orders. People outside of China need a longer time.

If there is a way that can make Chinese character beginners who have never contacted with Chinese characters to complete the second step within a few months just need to know the gaps, the potential gaps, the vertical lines, the horizontal lines, and the turning lines, it will greatly reduce the difficulty which the Chinese character beginners realize to record Chinese character information smoothly according to Chinese character stroke orders by using an information recording appliance, greatly shorten the time which the Chinese character beginners realize to record Chinese character information smoothly according to Chinese character stroke orders by using an information recording appliance.

### DISCLOSURE

### Technical Problem

The present application is to improve a basic step of the existing Chinese character information recording technology, thus reduce the difficulty which the Chinese character beginners realize to record Chinese character information smoothly according to Chinese character stroke orders by using an information recording appliance, shorten the time which the Chinese character beginners realize to record Chinese character information smoothly according to Chinese character stroke orders by using an information recording appliance.

### Technical Solution

The Chinese character information recording method provides the following solution:

A Chinese character information recording method, comprising: a step for recognizing Chinese character strokes, a step for recognizing Chinese character stroke orders, and a step for recording Chinese characters according to Chinese character stroke orders by using an information recording appliance; wherein said step for recognizing Chinese character stroke orders comprises a step for recognizing Chinese character stroke orders according to a Chinese character stroke order quick recognition method and a step for recognizing Chinese character stroke orders contrasting a table of Chinese character stroke order special situation;

The Chinese character stroke order quick recognition method is described herein: contrast the following method from the first item to the last item, obtain a Chinese character structure to split into two parts according to the first suitable one; obtain the two parts which have been split to respectively contrast the following method from the first item to the last item, and split into two parts according to the first suitable one again; and so on, until cannot continue to split according to the following method:

A. obtain a vertical line to run through a vertical gap of a Chinese character structure, the left part of the vertical line is first recording part, the right part of the vertical line is after recording part; when there is no vertical gap which can be run through,

B. obtain a horizontal line to run through a horizontal gap of a Chinese character structure, the above part of the horizontal line is first recording part, the below part of the horizontal line is after recording part; when there is no horizontal gap which can be run through,

C. obtain a turning line to run through a turning gap of a Chinese character structure, the outside part of the turning line is first recording part, the inside part of the turning line is after recording part; when there is no turning gap which can be run through,

D. obtain a turning line to run through a turning potential gap of a Chinese character structure, the outside part of the turning line is first recording part, the inside part of the turning line is after recording part; when there is no turning potential gap which can be run through,

The table of Chinese character stroke order special situation comprises the Chinese character structures which are processed according to Chinese character stroke order quick recognition method and which the got stroke orders are different from the standard stroke orders, and the basic Chinese character structures which do not be processed according to Chinese character stroke order quick recognition method.

The method can also be increased an item: “obtain a horizontal line to run through a horizontal potential gap of a Chinese character structure, the above part of the horizontal line is first recording part, the below part of the horizontal line is after recording part; when there is no horizontal potential gap which can be run through,”, as an item E be increased behind the item D, or as an item C2 be increased behind the item C and closing to the item C, or as an item B2 be increased behind the item B and closing to the item B, or as an item A2 be increased behind the item A and closing to the item A.

The method can also be changed the item B into an item B3: obtain a horizontal line to run through a horizontal gap or a horizontal potential gap of a Chinese character structure, the above part of the horizontal line is first recording part, the below part of the horizontal line is after recording part; when there is no horizontal gap or a horizontal potential gap which can be run through.

The method can also be canceled the item D, and be changed the item C into an item C3: obtain a turning line to run through a turning gap or a turning potential gap of a Chinese character structure, the outside part of the turning line is first recording part, the inside part of the turning line is after recording part; when there is no turning gap or a turning potential gap which can be run through.

The method can also be increased an item again: “obtain a vertical line to run through a vertical potential gap of a Chinese character structure, the left part of the vertical line is first recording part, the right part of the vertical line is after recording part; when there is no vertical potential gap which can be run through,”, as an item F be increased behind the last item, or as an item C4 be increased before the item D and closing to the item D, or as an item B4 be increased before the item C and closing to the item C.

The information recording appliance referred to in the Chinese character information recording method can be a computer system which has been equipped with the Chinese character input function and equipment.

Chinese characters have experienced thousands of years of changes. The situations are complex. In order to solve these complex situations, the following points make supplementary description for the Chinese character stroke order quick recognition method:

a. The horizontal lines referred to in the method comprise the slash “I” which resembles the Chinese character stroke “Lift”.

b. The turning lines referred to in the method refer to the turning lines which have one and only one zigzag main body; the zigzag main body turns around all or most of a part of a Chinese character structure; this part is “the inside part of the turning line”, then the other part of the Chinese character structure is “the outside part of the turning line”. Both the inside part and the outside part of the turning line are not empty. Do not obtain a turning line which the zigzag main body is undistinguishable to split a Chinese character structure.

c. In a Chinese character structure, there are separation, connection and intersection three kinds of relations between two strokes. We think: there is a gap between two separate strokes; there is a potential gap between two connective strokes, just like there is a potential gap between a chair and the ground, just like there is a potential gap between an object which has been posed on the wall and the wall. The “run through a . . . gap of a Chinese character structure” referred to in the method refers to a split line (a vertical line, a horizontal line, or a turning line) which runs through a Chinese character structure does not cut off any one stroke, the split line walking in the gap of two parts of a Chinese character structure from beginning to end, the two ends of the split line can be forward extended without blocking or connected without blocking. The “run through a . . . potential gap of a Chinese character structure” referred to in the method refers to a split line (a vertical line, a horizontal line, or a turning line) which runs through a Chinese character structure does not cut off any one stroke, the split line walking in the gap or the potential gap of two parts of a Chinese character structure from beginning to end, the two ends of the split line can be forward extended without blocking or connected without blocking, and the split line runs through at least one potential gap. The “does not cut off any one stroke” is a concept. In the concrete implementation, draw a visible and certain width line to run through a potential gap, must cover the strokes on both sides of the potential gap; draw a line to run through a small gap, also may cover the strokes on both sides of the gap. At this time, do not consider that have cut off the strokes.

d. The gaps or potential gaps of the Chinese character structures are not always straight, many are uneven. So the vertical lines, the horizontal lines and the vertical sections of the turning lines, the horizontal sections of the turning lines referred to in the method, some are straight, some are curve, some are wavy. Do not deliberately zigzag the split lines when split.

e. In the outside part of the turning line, the stroke (strokes) completely below the inside part of the turning line is (are) recorded after the inside part of the turning line has been recorded. In the outside part of the turning line, it contains the stroke (strokes) which extends (extend) to the underside of the inside part of the turning line from the left side, and there is (are) half or more than half a stroke (strokes) below the inside part of the turning line in the outside part of the turning line, then the outside part of the turning line is recorded after the inside part of the turning line has been recorded; can also take “one third or more than one third” to replace the “half or more than half”.

f. When obtain a split mode, the “Lift” and “Hook” at the end of a stroke of a Chinese character structure can be ignored.

g. When obtain a vertical line or a horizontal line to split, there is more than one split mode, can obtain any one of them.

h. When obtain a turning line to split, there is more than one split mode, can skip this item and obtain another split mode in the follow-on items, or process as follows:

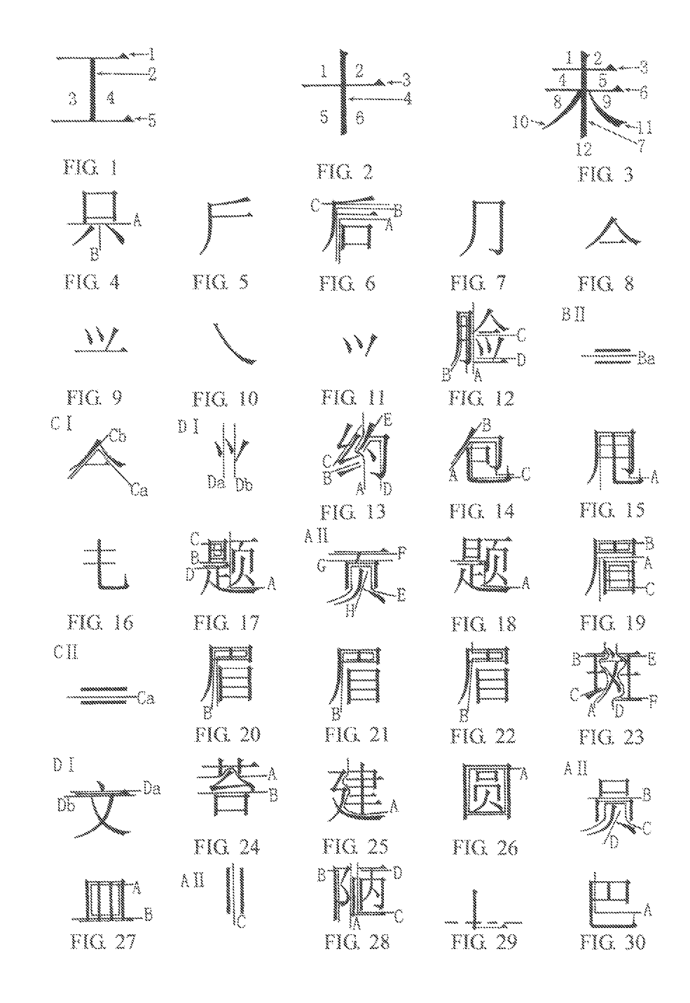

h1. A Chinese character structure contains a “ [symbol] ” group structure, and the “ [symbol] ” group structure divides the Chinese character structure out left and right two intervals, thus appears more than one split mode which can obtain the turning line to split. Split the intervals which need to be split according to the order which the number signs without arrow have displayed in FIG. 1, and record the Chinese character structure according to the order displayed as FIG. 1. It can be empty no strokes in the intervals which the “ [symbol] ” group structure divides out. Each part which composes a “ [symbol] ” group structure is not always complete, it can be cut, so the “ [symbol] ” group structure can comprise “ [symbol] ” type, “ [symbol] ” type, “ [symbol] ” type, etc.; the recording order of each type is correspondingly cut on the basis of the “ [symbol] ” type recording order. The connective upper part, middle part and lower part of the “ [symbol] ” group structure represents a Chinese character structure each.

h2. A Chinese character structure contains a “beaded” structure, and the “beaded” structure divides the Chinese character structure out upper-left, upper-right, lower-left, and lower-right four intervals, thus appears more than one split mode which can obtain the turning line to split. Split the intervals which need to be split according to the order which the number signs without arrow have displayed in FIG. 2, and record the Chinese character structure according to the order displayed as FIG. 2. It can be empty no strokes in the intervals which the “beaded” structure divides out. The intersecting horizontal section and vertical section of the “beaded” structure represents a Chinese character structure each.

h3. A Chinese character structure contains a “ [symbol] ” group structure, and the “ [symbol] ” group structure divides the Chinese character structure out a plurality of intervals, thus appears more than one split mode which can obtain the turning line to split. Split the intervals which need to be split according to the order which the number signs without arrow have displayed in FIG. 3, and record the Chinese character structure according to the order displayed as FIG. 3. It can be empty no strokes in the intervals which the “ [symbol] ” group structure divides out. Each part which composes a “ [symbol] ” group structure is not always complete, it can be cut, so the “ [symbol] ” group structure can comprise “ [symbol] ” type, “ [symbol] ” type, “ [symbol] ” type, “ [symbol] ” type, “ [symbol] ” type, “ [symbol] ” type, “ [symbol] ” type, etc.; the recording order of each type is correspondingly cut on the basis of the “ [symbol] ” type recording order. Each part which composes a “ [symbol] ” group structure represents a Chinese character structure each.

h4. Other situations, split according to a mode which the inside part of the turning line will get a maximum area.

h5. In the “ [symbol] ” group structure, “beaded” structure and “ [symbol] ” group structure, each component part and the within of each divided out interval represents a Chinese character structure each. Can separately list these Chinese character structures, continue to process according to the Chinese character stroke order quick recognition method, and determine the recording order (determine the recording order of these Chinese character structures under the premise which is following the total recording order of the “ [symbol] ” group structure or “beaded” structure or “ [symbol] ” group structure).

i. A Chinese character structure contains a plurality of separate subordinate Chinese character structures,

i1. Therein some subordinate Chinese character structures are left and right the same or around some Chinese character structure(s) left and right the same, these same subordinate Chinese character structures and the Chinese character structure(s) being surrounded as a Chinese character structure group integrally as far as possible are kept to the last stage to split, can obtain another split mode or obtain a split mode in follow-on other items.

i2. Therein some subordinate Chinese character structures are left and right symmetry or around some Chinese character structure(s) left and right symmetry, these symmetrical subordinate Chinese character structures and the Chinese character structure(s) being surrounded as a Chinese character structure group integrally as far as possible are kept to the last stage to split, can obtain another split mode or obtain a split mode in follow-on other items.

Split a Chinese character structure according to the Chinese character stroke order quick recognition method referred to in the Chinese character information recording method; mark out the vertical line(s), the horizontal line(s), the turning line(s) which is (are) involved in the split process and the split order in the Chinese character structure; the formed Chinese character stroke order recognition diagram, can intuitively display the Chinese character stroke order quick recognition method, make the recognizing process of most Chinese character stroke orders easier.

The Chinese character stroke order recognition diagram can also be described as a Chinese character stroke order recognition diagram preparing method, namely: split a Chinese character structure according to the Chinese character stroke order quick recognition method referred to in the Chinese character information recording method; mark out the vertical line(s), the horizontal line(s), the turning line(s) which is (are) involved in the split process and the split order in the Chinese character structure.

Split a Chinese character structure according to other methods, mark out the split lines which are involved in the split process and the split order in the Chinese character structure, can also form the corresponsive Chinese character stroke order recognition diagrams.

### SUMMARY OF THE INVENTION

### Advantageous Effects of Invention

Process the Chinese character structures according to the Chinese character stroke order quick recognition method; the got stroke orders, a part is the same as the standard stroke orders, the other part is different from the standard stroke orders. Take the Chinese character structures which are processed according to the Chinese character stroke order quick recognition method and which the got stroke orders are different from the standard stroke orders, and the basic Chinese character structures which do not be processed according to the Chinese character stroke order quick recognition method into the table of Chinese character stroke order special situation; this part of Chinese character structures are only a few, for instance, in the <Chinese Character Stroke Order Standard of GB13000.1 Character Set> which contains 20,902 Chinese characters and which released on Oct. 1, 1999 by National Language Script Work Committee of Ministry of Education of China, only less than 400, compared with 20,902 Chinese characters, less than 2%.

Thus, split a Chinese character structure step-by-step into several parts according to the simple rules of the Chinese character stroke order quick recognition method, and sequence these several parts, can recognize the rough stroke order of the Chinese character structure. By extension, can recognize the rough stroke orders of most Chinese character structures; and recognize the stroke orders of a few Chinese character structures of the table of Chinese character stroke order special situation, can completely recognize the stroke orders of most Chinese character structures. Combining with the step for recognizing Chinese character strokes and the step for recording Chinese characters according to Chinese character stroke orders by using an information recording appliance, can realize to record most Chinese characters smoothly, for instance, the 20,902 Chinese characters. Compared with existing method which takes 9 years to recognize 7,000 commonly-used Chinese characters, the Chinese character information recording method may help the Chinese character beginners who have never contacted with Chinese characters, especially the people outside of China learning Chinese, reduce the difficulty which realize to record Chinese characters smoothly according to Chinese character stroke orders by using an information recording appliance, shorten the time which realize to record Chinese characters smoothly according to Chinese character stroke orders by using an information recording appliance.

The Chinese character stroke order recognition diagram can intuitively display the Chinese character stroke order quick recognition method, thus further reduce the difficulty of the step for recognizing Chinese character stroke orders. So the solution which the step for recognizing Chinese character stroke orders comprises the Chinese character stroke order quick recognition method, the table of Chinese character stroke order special situation and the Chinese character stroke order recognition diagram may further reduce the difficulty which the Chinese character beginners realize to record Chinese characters smoothly according to Chinese character stroke orders by using an information recording appliance, shorten the time which the Chinese character beginners realize to record Chinese characters smoothly according to Chinese character stroke orders by using an information recording appliance.

### BRIEF DESCRIPTION OF DRAWINGS

### Description of Drawings

The present application will be further described below, by way of example, with reference to the accompanying drawings.

FIGS. 1, 2, 3 and 80 are recording order diagrams of “ [symbol] ” type of “ [symbol] ” group structure, “ [symbol] ” type of “beaded” structure, “ [symbol] ” type of “ [symbol] ” group structure and like “ [symbol] ” group structure, respectively. FIG. 4 to FIG. 79 are displayed Figures of the Chinese character structures which are displayed in corresponsive Figures or Chinese character stroke order recognition diagrams of the Chinese character structures which are displayed in corresponsive Figures.

In FIGS. 1, 2, and 3, the number signs with arrow are the signs of each part which composes each type structure; the number signs without arrow are the signs of the Chinese character structures within the interval which the number sign is situated; the recording order of each type structure is consistent with the number sign order. In FIG. 4 to FIG. 79, “ [symbol] ” group, “beaded”, “ [symbol] ” group, and “special” are four short catchwords indispensable for understanding the present application; due to FIG. 4 to FIG. 79 are the related images to the Chinese characters, and these four short catchwords are Chinese characters, for the purpose distinguishing from the other parts of each Figure and saving space, these four short catchwords are placed between parentheses.

According to the characteristics of the Chinese character stroke order recognition diagram, in drawings, the numbers of the Chinese character stroke order recognition diagrams are marked below the front of the Figure. Thus, has appeared such situation: the Figure before a number belongs to the range of the Figure of the immediate prior number. For example, the Figure before the number “FIG. 2” belongs to FIG. 1; the Figure before the number “FIG. 3” belongs to FIG. 2. And for example, the Figure before the number “FIG. 12” belongs to FIG. 11; the Figure before the number “FIG. 13” belongs to FIG. 12; so FIG. 12 contains four small diagrams. In FIG. 1 to FIG. 80, the quantities of small diagrams which each Figure contains as follows (in order to describe simply, for instance, FIG. 12 contains four small diagrams, abbreviated as “FIG. 12-4”, FIG. 17 contains two small diagrams, abbreviated as “FIG. 17-2”.): FIG. 12-4, FIG. 17-2, FIG. 19-2, FIG. 23-2, FIG. 26-2, FIG. 27-2, FIG. 30-2, FIG. 42-2, FIG. 46-4, FIG. 47-2, FIG. 48-2, FIG. 49-3, FIG. 50-2, FIG. 51-4, FIG. 52-2, FIG. 53-2, FIG. 54-2, FIG. 55-2, FIG. 56-2, FIG. 57-4, FIG. 58-2, FIG. 59-2, FIG. 60-2, FIG. 73-2, FIG. 74-2, FIG. 75-2, FIG. 76-2, FIG. 77-4; every rest Figures contains one small diagram.

### DETAILED DESCRIPTION

### Best Mode

When obtain a split mode according to the Chinese character stroke order quick recognition method referred to in the present application, it is the best mode for the Chinese character information recording method and Chinese character stroke order recognition diagram that accord to the order of item A, item B, item C, item D, item E, item F.

### MODE FOR INVENTION

In the Chinese character information recording method, the first step and the third step are the same as existing other methods; the following give the mode for the characteristic step for recognizing Chinese character stroke orders and the Chinese character stroke order recognition diagram.

In the mode, when obtain a split mode according to the Chinese character stroke order quick recognition method, accord to the order of item A, item B, item C, item D, item E, item F. Accord to other orders when obtain a split mode, except the split order is different and the Chinese character structures which the table of Chinese character stroke order special situation contains are different that caused of the difference of the split order, other situations are the same. In order to illustrate simply, the character form regulation and stroke order regulation of Chinese characters which are used to illustrate are given priority to the regulation of mainland China; the Chinese characters under other character form regulations and stroke order regulations can also be processed by the Chinese character information recording method. In order to describe simply, “contrast the Chinese character stroke order quick recognition method from the first item to the last item, the item one is the first suitable one, so split according to this item.” simply describes as “according to the item one” in the following description.

Example 1: recognizing the stroke order of “ [symbol] ”.

1. To split the “ [symbol] ”. According to the item B, obtain a horizontal line to run through the horizontal gap of the “ [symbol] ”. The “ [symbol] ” above the horizontal line is first recording part; the “ [symbol] ” below the horizontal line is after recording part. The “ [symbol] ” is the basic Chinese character structure of the table of Chinese character stroke order special situation, do not split it according to the method; then split the “ [symbol] ”.

2. To split the “ [symbol] ”. According to the item A, obtain a vertical line to run through the vertical gap of the “ [symbol] ”. The “ [symbol] ” at the left of the vertical line is first recording part; the “ [symbol] ” at the right of the vertical line is after recording part. Both these two parts are single strokes, no longer split them.

Thus, the stroke order of the “ [symbol] ” is: [symbol] , [symbol] , [symbol] . As long as recognizing the stroke order of the “ [symbol] ”, then can complete recognize the stroke order of “ [symbol] ”.

The Chinese character stroke order recognition diagram of “ [symbol] ” is displayed as FIG. 4. A, B are the split order signs of “ [symbol] ” in the diagram, rather than split “according to the item one”; the split order is the same as alphabetical. From the Chinese character stroke order recognition diagram of “ [symbol] ” can know:

The first step is to split “ [symbol] ”. Obtain a horizontal line A to run through the horizontal gap of the “ [symbol] ”. The “ [symbol] ” above the horizontal line A is first recording part; the “ [symbol] ” below the horizontal line A is after recording part.

The second step is to split “ [symbol] ”. Obtain a vertical line B to run through the vertical gap of the “ [symbol] ”. The “ [symbol] ” at the left of the vertical line B is first recording part; the “ [symbol] ” at the right of the vertical line B is after recording part.

Thus, from the Chinese character stroke order recognition diagram of “ [symbol] ” can know the stroke order of “ [symbol] ” is: [symbol] , [symbol] , [symbol] .

Example 2: recognizing the stroke order of “ [symbol] ”.

1. To split “ [symbol] ”. According to the item C, obtain a turning line to run through its turning gap. The outside part of the turning line displayed as FIG. 5 is first recording part; the “ [symbol] ” of the inside part of the turning line is after recording part. The “ [symbol] ” is the basic Chinese character structure of the table of Chinese character stroke order special situation, do not split it according to the method; then split the Chinese character structure displayed as FIG. 5.

2. To split the Chinese character structure displayed as FIG. 5. According to the item D, obtain a turning line to run through its turning potential gap. The “ [symbol] ” of the outside part of the turning line is first recording part; the “ [symbol] ” of the inside part of the turning line is after recording part. The “ [symbol] ” is a single stroke, no longer split it; then split the “ [symbol] ”.

3. To split “ [symbol] ”. According to the item E, obtain a horizontal line to run through its horizontal potential gap. The “ [symbol] ” above the horizontal line is first recording part; the “ [symbol] ” below the horizontal line is after recording part. Both these two parts are single strokes, no longer split them.

Thus, the stroke order of “ [symbol] ” is: [symbol] , [symbol] , [symbol] , [symbol] . As long as recognizing the stroke order of the “ [symbol] ”, then can complete recognize the stroke order of “ [symbol] ”.

The Chinese character stroke order recognition diagram of “ [symbol] ” is displayed as FIG. 6, from it can know:

The first step is to split “ [symbol] ”. Obtain a turning line A to run through its turning gap. The outside part of the turning line A displayed as FIG. 5 is first recording part; the “ [symbol] ” of the inside part of the turning line A is after recording part.

The second step is to split the Chinese character structure displayed as FIG. 5. Obtain a turning line B to run through its turning potential gap. The “ [symbol] ” of the outside part of the turning line B is first recording part; the “ [symbol] ” of the inside part of the turning line B is after recording part.

The third step is to split “ [symbol] ”. Obtain a horizontal line C to run through its horizontal potential gap. The “ [symbol] ” above the horizontal line C is first recording part; the “ [symbol] ” below the horizontal line C is after recording part.

Thus, from the Chinese character stroke order recognition diagram of “ [symbol] ” can know the stroke order of “ [symbol] ” is: [symbol] , [symbol] , [symbol] , [symbol] .

Example 3: recognizing the stroke order of “ [symbol] ”.

1. To split “ [symbol] ”. According to the item A, obtain a vertical line to run through its vertical gap. The “ [symbol] ” at the left of the vertical line is first recording part; the “ [symbol] ” at the right of the vertical line is after recording part. Then respectively split “ [symbol] ” and “ [symbol] ” these two parts.

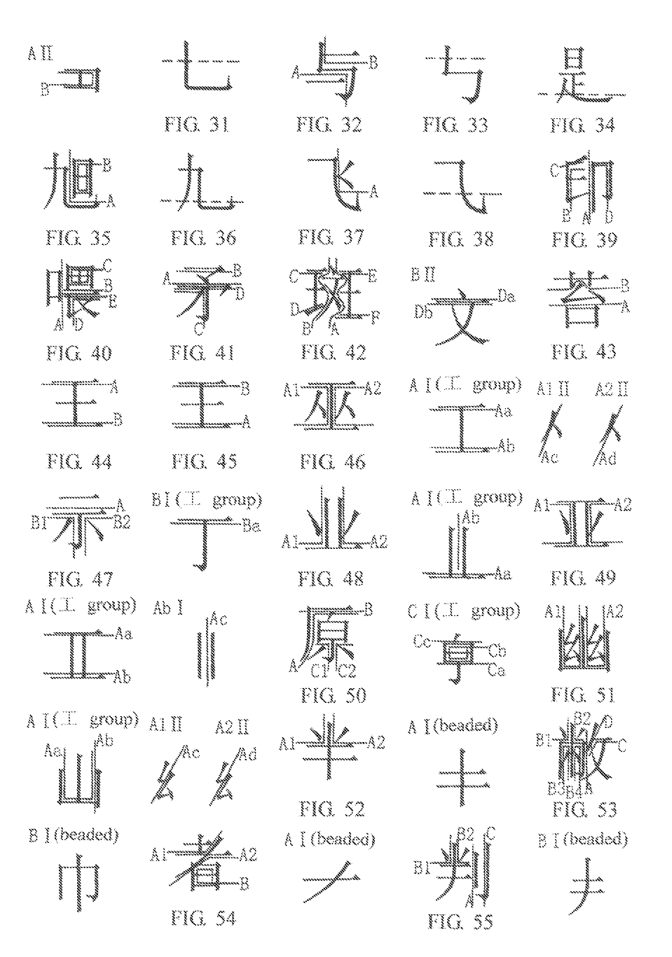

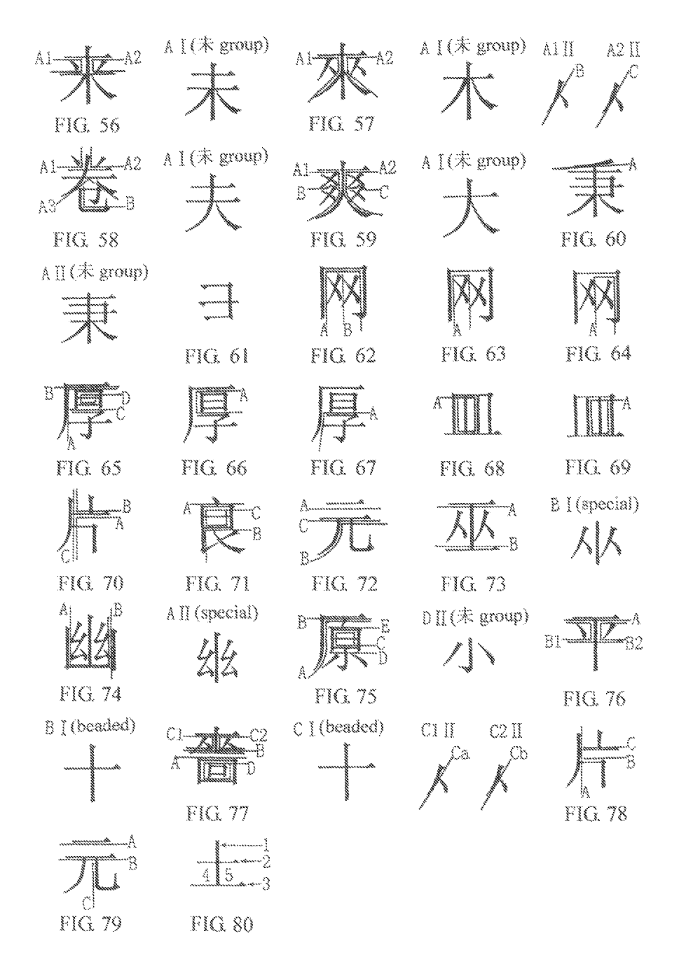

2. To split “ [symbol] ”. According to the item D, obtain a turning line to run through its turning potential gap. The outside part of the turning line displayed as FIG. 7 is first recording part; the “ [symbol] ” of the inside part of the turning line is after recording part. The Chinese character structure displayed as FIG. 7 is the basic Chinese character structure of the table of Chinese character stroke order special situation, do not split it according to the method; then split the “ [symbol] ”.

3. To split “ [symbol] ”. According to the item B, obtain a horizontal line to run through its horizontal gap. The “ [symbol] ” above the horizontal line is first recording part; the “ [symbol] ” below the horizontal line is after recording part. Both these two parts are single strokes, no longer split them.

4. To split “ [symbol] ”. According to the item B, obtain a horizontal line to run through its horizontal gap. The part above the horizontal line displayed as FIG. 8 is first recording part; the part below the horizontal line displayed as FIG. 9 is after recording part. Then respectively split these two parts.

5. To split the Chinese character structure displayed as FIG. 8. According to the item C, obtain a turning line to run through its turning gap. The “ [symbol] ” of the outside part of the turning line is first recording part; the “ [symbol] ” of the inside part of the turning line is after recording part. The “ [symbol] ” is a single stroke, no longer split it; then split the “ [symbol] ”.

6. To split “ [symbol] ”. According to the item E, obtain a horizontal line to run through its horizontal potential gap. The “ [symbol] ” above the horizontal line is first recording part; the part below the horizontal line displayed as FIG. 10 is after recording part. Both these two parts are single strokes, no longer split them.

7. To split the Chinese character structure displayed as FIG. 9. According to the item B, obtain a horizontal line to run through its horizontal gap. The part above the horizontal line displayed as FIG. 11 is first recording part; the “ [symbol] ” below the horizontal line is after recording part. The “ [symbol] ” is a single stroke, no longer split it; then split the Chinese character structure displayed as FIG. 11.

8. To split the Chinese character structure displayed as FIG. 11. According to the item A, obtain a vertical line to run through its vertical gap. The “ [symbol] ” at the left of the vertical line is first recording part; the “ [symbol] ” at the right of the vertical line is after recording part. The “ [symbol] ” is a single stroke, no longer split it; then split the “ [symbol] ”

9. To split “ [symbol] ”. According to the item A, obtain a vertical line to run through its vertical gap. The “ [symbol] ” at the left of the vertical line is first recording part; the “ [symbol] ” at the right of the vertical line is after recording part. Both these two parts are single strokes, no longer split them.

Thus, the stroke order of “ [symbol] ” is: “the Chinese character structure displayed as FIG. 7”, [symbol] , “the Chinese character structure displayed as FIG. 10”, [symbol] . As long as recognizing the stroke order of the Chinese character structure displayed as FIG. 7, then can complete recognize the stroke order of “ [symbol] ”.

The Chinese character stroke order recognition diagram of “ [symbol] ” is displayed as FIG. 12. A, B, Ba, C, Ca, Cb, D, Da, Db are the split order signs of “ [symbol] ” in the diagram, rather than split “according to the item one”; the split order is the same as alphabetical. Rome numeral “I” indicates first recording parts, comprising the parts at the left of the vertical line, above the horizontal line, outside of the turning line; “II” indicates after recording parts, comprising the parts at the right of the vertical line, below the horizontal line, inside of the turning line; for instance, B II indicates the after recording part which has got after the B step split; C I indicates the first recording part which has got after the C step split; D I indicates the first recording part which has got after the D step split. Thus, from the Chinese character stroke order recognition diagram FIG. 12 of “ [symbol] ” can know:

The first step is to split “ [symbol] ”. Obtain a vertical line A to run through its vertical gap. The “ [symbol] ” at the left of the vertical line A is first recording part; the “ [symbol] ” at the right of the vertical line A is after recording part.

The second step is to split “ [symbol] ”. Obtain a turning line B to run through its turning potential gap. The outside part of the turning line B displayed as FIG. 7 is first recording part; the “ [symbol] ” of the inside part of the turning line B is after recording part; in order to facilitate the next split, separately list the “ [symbol] ”, and mark by B II.

The third step is to split “ [symbol] ”. Obtain a horizontal line Ba to run through its horizontal gap. The “ [symbol] ” above the horizontal line Ba is first recording part; the “ [symbol] ” below the horizontal line Ba is after recording part.

The fourth step is to split “ [symbol] ”. Obtain a horizontal line C to run through its horizontal gap. The part above the horizontal line C displayed as FIG. 8 is first recording part, separately list it and mark by C I; the part below the horizontal line C displayed as FIG. 9 is after recording part.

The fifth step is to split the Chinese character structure displayed as C I. Obtain a turning line Ca to run through its turning gap. The “ [symbol] ” of the outside part of the turning line Ca is first recording part; the “ [symbol] ” of the inside part of the turning line is after recording part.

The sixth step is to split “ [symbol] ”. Obtain a horizontal line Cb to run through its horizontal potential gap. The “ [symbol] ” above the horizontal line Cb is first recording part; the part below the horizontal line displayed as FIG. 10 is after recording part.

The seventh step is to split the Chinese character structure displayed as FIG. 9. Obtain a horizontal line D to run through its horizontal gap. The part above the horizontal line D displayed as FIG. 11 is first recording part, separately list it and mark by D I; the “ [symbol] ” below the horizontal line is after recording part.

The eighth step is to split the Chinese character structure displayed as D I. Obtain a vertical line Da to run through its vertical gap. The “ [symbol] ” at the left of the vertical line Da is first recording part; the “ [symbol] ” at the right of the vertical line is after recording part.

The ninth step is to split “ [symbol] ”. Obtain a vertical line Db to run through its vertical gap. The “ [symbol] ” at the left of the vertical line Db is first recording part; the “ [symbol] ” at the right of the vertical line Db is after recording part.

Thus from the Chinese character stroke order recognition diagram of “ [symbol] ” can know the stroke order of “ [symbol] ” is: “FIG. 7”, [symbol] , “FIG. 10”, [symbol] , [symbol] .

Due to exist different character from regulation of Chinese characters, and you can more easily understand the Chinese character stroke order quick recognition method by starting from the simple example. Thus take the “ [symbol] ” into the table of Chinese character stroke order special situation in examples 1, 2. In fact, according to different character from regulation, can also split “ [symbol] ” into “ [symbol] ” and “ [symbol] ” according to the item D or according to the item E.

Make further explanation for the part of supplementary description of Chinese character stroke order quick recognition method below.

Example 4: the Chinese character stroke order recognition diagram of “ [symbol] ” is displayed as FIG. 13. The B step is to obtain the “ [symbol] ” which is comprised in the horizontal line to run through the horizontal gap. The C, E steps are to obtain the “ [symbol] ” which is comprised in the horizontal line to run through the horizontal potential gaps.

Example 5: the Chinese character stroke order recognition diagram of “ [symbol] ” is displayed as FIG. 14. The A step is to obtain a turning line A to run through the turning gap of “ [symbol] ”. The left part of the turning line A is the zigzag main body, it zigzagged around the most part of “ [symbol] ”; thus “ [symbol] ” is the inside part of the turning line.

Example 6: the Chinese character stroke order recognition diagram of “ [symbol] ” is displayed as FIG. 15. The A step is to obtain a turning line A to run through the turning potential gap. The left part of the turning line A is the zigzag main body, it zigzagged around the most part of the Chinese character structure displayed as FIG. 16; thus the Chinese character structure displayed as FIG. 16 is the inside part of the turning line.

Example 7: the Chinese character stroke order recognition diagram of “ [symbol] ” is displayed as FIG. 17. The A step is to obtain a turning line A to run through the turning gap of “ [symbol] ”. Due to the zigzag main body is undistinguishable, do not obtain a turning line A displayed as FIG. 18 to split “ [symbol] ”.

Example 8: the Chinese character stroke order recognition diagram of “ [symbol] ” is displayed as FIG. 19. The B step is to obtain a turning line B to run through the turning potential gap of “ [symbol] ”. In the Chinese character stroke order recognition diagram, sometimes in order to indicate clearly, add a short-line between the split line and the sign of letter as indication, as the turning line B in FIG. 19 displayed. Due to two ends of the turning line directly neighbor, do not walk in the gap or potential gap of two parts of a Chinese character structure from beginning to end, thus do not obtain the turning line B to split as FIG. 20 displayed. Due to one end of the turning line cannot be forward extended without blocking or cannot be connected with the other end without blocking, thus do not obtain the turning line B to split as FIG. 21 displayed. Due to the zigzag main body is undistinguishable, thus do not obtain the turning line B to split as FIG. 22 displayed.

The “from beginning to end” referred to in the point c refers to the split line cannot run through between two parts in the middle, but the two ends of the split line directly neighbor, as FIG. 20 displayed; the Chinese character structures on both sides of the split line do not be required closed from beginning to end, for instance, the underside of the horizontal line D is completely closed, but the upside has open gaps, as FIG. 12 displayed, it is allowed; the split line as far as possible run through in the gap or potential gap, but when it is inevitable, the ends of the split line do not be required that there are Chinese character structures covered at the same time from beginning to end on both sides, for instance, there is Chinese character structure covered with wide range on the upside of horizontal line F, but there is Chinese character structure covered only on a part of the middle on the underside, there is not Chinese character structure covered at two ends on the underside, as FIG. 17 displayed, it is allowed.

Example 9: the Chinese character stroke order recognition diagram of “ [symbol] ” is displayed as FIG. 23. The A, D steps are to obtain a wavy vertical line to run through the vertical gaps. In order not to deliberately zigzag the split line, Da is obtained a horizontal line rather than a turning line; another example, in FIG. 17, both F and G are obtained horizontal lines rather than turning lines.

Example 10: the Chinese character stroke order recognition diagram of “ [symbol] ” is displayed as FIG. 24. The A step is to obtain a wavy horizontal line to run through the horizontal gap.

Example 11: the Chinese character stroke order recognition diagram of “ [symbol] ” is displayed as FIG. 25. The A step is to obtain a turning line which the vertical section presents wave to run through the turning gap.

Example 12: the Chinese character stroke order recognition diagram of “ [symbol] ” is displayed as FIG. 26. The A step is to obtain a turning line A to run through the turning gap of “ [symbol] ”. The “ [symbol] ” of the outside part of the turning line A is first recording part; the “ [symbol] ” of the inside part is after recording part. The “ [symbol] ” at the bottom of the “ [symbol] ” is completely below the “ [symbol] ”, thus this “ [symbol] ” is recorded after the “ [symbol] ” has been recorded. The recording order of “ [symbol] ” is: [symbol] , [symbol] , [symbol] .

Example 13: the Chinese character stroke order recognition diagram of “ [symbol] ” is displayed as FIG. 27. The “ [symbol] ” at the bottom of the A I part is completely below the A II part, thus this “ [symbol] ” is recorded after the A II part has been recorded. The recording order of “ [symbol] ” is: [symbol] .

Example 14: the Chinese character stroke order recognition diagram of “ [symbol] ” is displayed as FIG. 28. The C I part contains the stroke which extends to the underside of the C II part from the left side, and there is half a stroke below the C II part, displayed as the part below the dotted line in FIG. 29; thus the C I part is recorded after the C II part has been recorded.

Example 15: the Chinese character stroke order recognition diagram of “ [symbol] ” is displayed as FIG. 30. The A I part contains the stroke which extends to the underside of the A II part from the left side, and there is more than half a stroke below the A II part, displayed as the part below the dotted line in FIG. 31; thus the A I part is recorded after the A II part has been recorded.

Example 16: the Chinese character stroke order recognition diagram of “ [symbol] ” is displayed as FIG. 32. The B I part contains the stroke which extends to the underside of the B II part from the left side, and there is more than half a stroke below the B II part, displayed as the part below the dotted line in FIG. 33; thus the B I part is recorded after the B II part has been recorded.

Example 17: the Chinese character stroke order recognition diagram of “ [symbol] ” is displayed as FIG. 17. The A I part contains the strokes which extend to the underside of the A II part from the left side, but there are only less than half strokes below the A II part, displayed as the part below the dotted line in FIG. 34; thus all of the A I part, including the strokes which extend to the underside of the A II part from the left side, are recorded before the A II part has been recorded.

Example 18: the Chinese character stroke order recognition diagram of “ [symbol] ” is displayed as FIG. 35. The A I part contains the strokes which extend to the underside of the A II part from the left side, but there are only less than half strokes below the A II part, displayed as the part below the dotted line in FIG. 36; thus all of the A I part, including the strokes which extend to the underside of the A II part from the left side, are recorded before the A II part has been recorded.

Example 19: the Chinese character stroke order recognition diagram of “ [symbol] ” is displayed as FIG. 37. The A I part contains the stroke which extends to the underside of the A II part from the left side, but there is only less than half a stroke below the A II part, displayed as the part below the dotted line in FIG. 38; thus the A I part is recorded before the A II part has been recorded.

First half sentence of the second sentence in the point e can be further defined as: “In the outside part of the turning line, it contains the stroke (strokes) which extends (extend) to the underside of the inside part of the turning line from the left side, and there is (are) half or more than half a stroke (strokes) below the inside part of the turning line in the outside part of the turning line (after being removed the stroke(s) completely above the inside part of the turning line), then the outside part of the turning line (after being removed the stroke(s) completely above the inside part of the turning line) is recorded after the inside part of the turning line has been recorded;”. For example, the stroke “ [symbol] ” of “ [symbol] ” is recorded after the inside part “ [symbol] ” of the turning line has been recorded; due to the other parts of the outside part of the turning line are completely above the inside part “ [symbol] ” of the turning line, still first recorded following “the outside part of the turning line is first recording part”.

Example 20: the Chinese character stroke order recognition diagram of “ [symbol] ” is displayed as FIG. 39. When the B step splits, ignore the “Lift” at the end of the stroke “ [symbol] ” in the B I part.

Example 21: the Chinese character stroke order recognition diagram of “ [symbol] ” is displayed as FIG. 40. When the D step splits, ignore the “Lift” at the end of the stroke “ [symbol] ” in the D I part.

Example 22: the Chinese character stroke order recognition diagram of “ [symbol] ” is displayed as FIG. 41. When the B, C, D steps split, ignore the “Hook” at the end of the strokes.

Example 23: the Chinese character stroke order recognition diagrams of “ [symbol] ” as FIG. 23 and FIG. 42 displayed are both correct. The first step is to obtain a vertical line A to run through the vertical gap of “ [symbol] ”. There are two modes to run through, can obtain any one, namely can obtain the mode as FIG. 23 or FIG. 42 displayed.

Example 24: the Chinese character stroke order recognition diagrams of “ [symbol] ” as FIG. 24 and FIG. 43 displayed are both correct. The first step is to obtain a horizontal line A to run through the horizontal gap of “ [symbol] ”. There are two modes to run through, can obtain any one, namely can obtain the mode as FIG. 24 or FIG. 43 displayed.

Example 25: the Chinese character stroke order recognition diagrams of “ [symbol] ” as FIG. 44 and FIG. 45 displayed are both correct. The first step is to obtain a horizontal line A to run through the horizontal potential gap of “ [symbol] ”. There are two modes to run through, can obtain any one, namely can obtain the mode as FIG. 44 or FIG. 45 displayed.

Example 26: the Chinese character stroke order recognition diagram of “ [symbol] ” is displayed as FIG. 46. The first step is to obtain a turning line to run through the turning gap of “ [symbol] ”. There are two modes to run through; after running through these two turning gaps, a “ [symbol] ” group structure will be left over. Thus obtain the turning lines A1 and A2 to respectively run through two turning gaps in the same step A, and A1 precedes A2. A I is first recording part which has got after the step A split; A1 II and A2 II respectively indicate the after recording parts which have got after obtaining the turning lines A1, A2 to split. The A I part of this example is the “ [symbol] ” type of “ [symbol] ” group structure. The A1 II part and A2 II part are respectively continued split according to the point h5. Referencing the recording order of “ [symbol] ” group structure, the stroke order of “ [symbol] ” is: [symbol] .

Example 27: the Chinese character stroke order recognition diagram of “ [symbol] ” is displayed as FIG. 47. The B I part is “ [symbol] ” type of “ [symbol] ” group structure, its middle part is the Chinese character structure “ [symbol] ”. Referencing the recording order of “ [symbol] ” group structure, the stroke order of “ [symbol] ” is: [symbol] , [symbol] .

Example 28: the Chinese character stroke order recognition diagram of “ [symbol] ” is displayed as FIG. 48. The A I part is “ [symbol] ” type of “ [symbol] ” group structure, its middle part is the Chinese character structure “ [symbol] ”. The Aa I part is continued split according to the point h5. Referencing the recording order of “ [symbol] ” group structure, the stroke order of “ [symbol] ” is: [symbol] .

Example 29: the Chinese character stroke order recognition diagram of “ [symbol] ” is displayed as FIG. 49. The A I part is “ [symbol] ” type of “ [symbol] ” group structure, its middle part is the Chinese character structure “ [symbol] ”. The Ab I part is continued split according to the point h5. Referencing the recording order of “ [symbol] ” group structure, the stroke order of “ [symbol] ” is: [symbol] .

Example 30: the Chinese character stroke order recognition diagram of “ [symbol] ” is displayed as FIG. 50. The C I part is “ [symbol] ” type of “ [symbol] ” group structure, its upper part is the Chinese character structure “ [symbol] ”, middle part is the Chinese character structure “ [symbol] ”. The C I part is continued split according to the point h5. Referencing the recording order of “ [symbol] ” group structure, the stroke order of “ [symbol] ” is: [symbol] [symbol] .

Example 31: the Chinese character stroke order recognition diagram of “ [symbol] ” is displayed as FIG. 51. The A I part is “ [symbol] ” type of “ [symbol] ” group structure, its lower part is the Chinese character structure “ [symbol] ”. The A1 II part and A2 II part are respectively continued split according to the point h5. Referencing the recording order of “ [symbol] ” group structure, the stroke order of“ [symbol] ” is: [symbol] , [symbol] , [symbol] .

Example 32: the Chinese character stroke order recognition diagram of “ [symbol] ” is displayed as FIG. 52. After obtaining the turning lines A1 and A2 to respectively run through two turning gaps in the same step A, the A I part is a “beaded” structure. It is empty no strokes in its lower-left, lower-right two intervals. Its horizontal part is the Chinese character structure “ [symbol] ”, its vertical part is the Chinese character structure “ [symbol] ”. Referencing the recording order of “beaded” structure, the stroke order of “ [symbol] ” is: [symbol] .

Example 33: the Chinese character stroke order recognition diagram of “ [symbol] ” is displayed as FIG. 53. Obtain the turning lines B1, B2, B3 and B4 to respectively run through four turning gaps in the same step B, and the orders are B1, B2, B3, B4. The got first recording part B I is a “beaded” structure. Its horizontal part is the Chinese character structure “ [symbol] ”, its vertical part is the Chinese character structure “ [symbol] ”. Referencing the recording order of “beaded” structure, the stroke order of “ [symbol] ” is: [symbol] , [symbol] .

Example 34: the Chinese character stroke order recognition diagram of “ [symbol] ” is displayed as FIG. 54. The A I part is a “beaded” structure. It is empty no strokes in its upper-right, lower-left two intervals. Its horizontal part is “ [symbol] ”, its vertical part is “ [symbol] ”. Referencing the recording order of “beaded” structure, the stroke order of “ [symbol] ” is: [symbol] .

Example 35: the Chinese character stroke order recognition diagram of “ [symbol] ” is displayed as FIG. 55. The B I part is a “beaded” structure. It is empty no strokes in its lower-left, lower-right two intervals. Its horizontal part is “ [symbol] ”, its vertical part is “ [symbol] ”. Referencing the recording order of “beaded” structure, the stroke order of “ [symbol] ” is: [symbol] .

Example 36: the Chinese character stroke order recognition diagram of “ [symbol] ” is displayed as FIG. 56. After obtaining the turning lines A1 and A2 to respectively run through two turning gaps in the same step A, the A I part is a “ [symbol] ” group structure. It is empty no strokes in a plurality of intervals which the “ [symbol] ” group structure has divided out. Referencing the recording order of “ [symbol] ” group structure, the stroke order of“ [symbol] ” is: [symbol] , “FIG. 10”.

Example 37: the Chinese character stroke order recognition diagram of “ [symbol] ” is displayed as FIG. 57. The A I part is a “ [symbol] ” group structure which has been cut. It is empty no strokes in a plurality of intervals which the “ [symbol] ” group structure has divided out. Referencing the recording order of “ [symbol] ” group structure, the stroke order of “ [symbol] ” is: [symbol] , “FIG. 10”.

Example 38: the Chinese character stroke order recognition diagram of “ [symbol] ” is displayed as FIG. 58. The A I part is a “ [symbol] ” group structure which has been cut. It is empty no strokes in a plurality of intervals which the “ [symbol] ” group structure has divided out. Referencing the recording order of “ [symbol] ” group structure, the stroke order of “ [symbol] ” is: [symbol] , “FIG. 10”, “ [symbol] ”.

Example 39: the Chinese character stroke order recognition diagram of “ [symbol] ” is displayed as FIG. 59. The A I part is a “ [symbol] ” group structure which has been cut. It is empty no strokes in a plurality of intervals which the “ [symbol] ” group structure has divided out. Referencing the recording order of “ [symbol] ” group structure, the stroke order of “ [symbol] ” is: [symbol] , “FIG. 10”.

Example 40: the Chinese character stroke order recognition diagram of “ [symbol] ” is displayed as FIG. 60. The A II part is a “ [symbol] ” group structure. One of its component part (the part which 6 indicates in FIG. 3) is the Chinese character structure displayed as FIG. 61.

Example 41: the Chinese character stroke order recognition diagram of “ [symbol] ” is displayed as FIG. 62. The A step is to obtain a turning line A to run through the turning gap. Due to there is more than one split mode, and does not contain the “ [symbol] ” group or the “beaded” or the “ [symbol] ” group structure, according to the point h4, split according to a mode which the inside part of the turning line will be got a maximum area. Due to the inside part of the turning line cannot be got a maximum area, thus do not obtain the mode displayed as FIG. 63 or 64 to split.

Example 42: the Chinese character stroke order recognition diagram of “ [symbol] ” is displayed as FIG. 65. The A step is according to the point h4, to split according to a mode which the inside part of the turning line will be got a maximum area. Due to the inside part of the turning line cannot be got a maximum area, thus do not obtain the mode displayed as FIG. 66 or 67 to split.

Example 43: the Chinese character stroke order recognition diagram of “ [symbol] ” is displayed as FIG. 27. The A step is according to the point h4, to split according to a mode which the inside part of the turning line will be got a maximum area. Due to the inside part of the turning line cannot be got a maximum area, thus do not obtain the mode displayed as FIG. 68 or 69 to split.

Example 44: the Chinese character stroke order recognition diagram of “ [symbol] ” is displayed as FIG. 70. The A step is according to the point h4, to split according to a mode which the inside part of the turning line will be got a maximum area.

Example 45: the Chinese character stroke order recognition diagram of “ [symbol] ” is displayed as FIG. 71. The B step is according to the point h4, to split according to a mode which the inside part of the turning line will be got a maximum area.

Example 46: the Chinese character stroke order recognition diagram of “ [symbol] ” is displayed as FIG. 72. The B step is according to the point h4, to split according to a mode which the inside part of the turning line will be got a maximum area.

Example 47: the Chinese character stroke order recognition diagram of “ [symbol] ” can also be displayed as FIG. 73. The first step should split according to the item C. But due to there are two split modes, so skip the item C, and obtain another split mode in the follow-on items. Thus obtain a horizontal line A to run through the horizontal potential gap of “ [symbol] ”. The second step should split according to the item C. But due to there are two split modes, so skip the item C, and obtain another split mode in the follow-on items. Thus obtain a horizontal line B to run through the horizontal potential gap of the A II part. The B I part belongs to the Chinese character stroke order special situation.

Example 48: the Chinese character stroke order recognition diagram of “ [symbol] ” can also be displayed as FIG. 74. The A step is the split mode which is obtained after skipping “according to the item C”. The A II part is the Chinese character stroke order special situation.

Example 49: the Chinese character stroke order recognition diagram of “ [symbol] ” can also be displayed as FIG. 75. The C step is the split mode which is obtained after skipping “according to the item C”. The D step is the split mode which is obtained after skipping “according to the item C” again. The D II part is a “ [symbol] ” group structure.

Example 50: the Chinese character stroke order recognition diagram of “ [symbol] ” is displayed as FIG. 76. The A step is the split mode which is obtained after skipping “according to the item C”. The B I part is a “beaded” structure.

Example 51: the Chinese character stroke order recognition diagram of “ [symbol] ” is displayed as FIG. 77. The B step is the split mode which is obtained after skipping “according to the item C”. The C I part is a “beaded” structure.

Example 52: the Chinese character stroke order recognition diagram of “ [symbol] ” is displayed as FIG. 60. The A step is the split mode which is obtained after skipping “according to the item D”. The A II part is a “ [symbol] ” group structure.

Example 53: the Chinese character stroke order recognition diagram of “ [symbol] ” can also be displayed as FIG. 78. The A step is the split mode which is obtained after skipping “according to the item D”.

Example 54: the Chinese character stroke order recognition diagram of “ [symbol] ” can also be displayed as FIG. 79. The B step is the split mode which is obtained after skipping “according to the item D”.

It is a simple method that recognize the Chinese character stroke orders according to “ [symbol] ” group structure, “beaded” structure and “ [symbol] ” group structure. It can give priority to process around them when the Chinese character structure contains these structures. Namely: in the split process, these structures and the Chinese character structures in the intervals which these structures have divided out as a whole (a Chinese character structure group) are kept down; process according to the points h1, h2, h3, and h5, and determine the stroke orders. It will form such a structure when skip one item and obtain another split mode, then give priority to such skip, for instance, example 50.

“ [symbol] ” group structure, “beaded” structure and “ [symbol] ” group structure respectively contain the characteristics which h1, h2, and h3 have described; each component part of them represents a Chinese character structure each, so “ [symbol] ”, “ [symbol] ”, “ [symbol] ”, etc., also respectively contain “ [symbol] ” group structure, “beaded” structure, “ [symbol] ” group structure. The top of the vertical part of the “beaded” structure need not always completely run through the horizontal part, so “ [symbol] ”, etc., also contain “beaded” structure. The two parts which 10 and 11 indicate in FIG. 3 can be separated, connective or intersecting, so “ [symbol] ”, etc., also contain “ [symbol] ” group structure. Due to the difference of character form regulation, in Chinese characters of Japanese (Japanese characters), appears such Chinese character structures which the stroke “Right Slope” (displayed as FIG. 10) of the Chinese character structures “ [symbol] ” and the stroke “Right Slope” of the upper part of “ [symbol] ” intersect with the stroke “ [symbol] ” above it; these Chinese character structures conform to the characteristics which h3 has described, still belong “ [symbol] ” group structure. There is partial overlap between “ [symbol] ” group structure and “ [symbol] ” group structure, there is partial overlap between “beaded” structure and “ [symbol] ” group structure. Namely some Chinese character structures can be regarded as containing “ [symbol] ” group structure, can also be regarded as containing “ [symbol] ” group structure; some Chinese character structures can be regarded as containing “beaded” structure, can also be regarded as containing “ [symbol] ” group structure. Meet the overlap situation, can obtain any one. For instance, “ [symbol] ” can be regarded as containing “beaded” structure, can also be regarded as containing “ [symbol] ” group structure.

“ [symbol] ” group structure can be replaced by “ [symbol] ” (simplified Chinese character) group structure. Such replaced, the 4 and 5 in FIG. 3 will be added arrows, respectively indicate the “ [symbol] ” and the “ [symbol] ”, and become the component parts of “ [symbol] ” group structure; other characteristics, “ [symbol] ” group structure and “ [symbol] ” group structure are the same. “ [symbol] ” group structure can also be replaced by “ [symbol] ” group structure. Such replaced, the 4, 5, 6 in FIG. 3 are canceled; other characteristics, “ [symbol] ” group structure and “ [symbol] ” group structure are the same.

Example 55: when split “ [symbol] ”, the first step should split according to the item A, but according to the point i1, in order to obtain the subordinate Chinese character structure group “ [symbol] ” which left and right are the same as far as possible to be kept to the last stage to split, obtain a split mode in follow-on items. Thus obtain a horizontal line to run through the horizontal gap of “ [symbol] ”; above the horizontal line is “ [symbol] ”, below the horizontal line is “ [symbol] ”.

Example 56: when split “ [symbol] ”, the first step should split according to the item A, but according to the point i2, in order to obtain the subordinate Chinese character structure group “ [symbol] ” which left and right are symmetry as far as possible to be kept to the last stage to split, obtain a split mode in follow-on items. Thus obtain a turning line to run through the turning gap of “ [symbol] ”; the outside part of turning line is “ [symbol] ”, the inside part of turning line is“ [symbol] ”.

The same Chinese character structure groups referred to in the point it comprise “ [symbol] ”, etc. The symmetry Chinese character structure groups referred to in the point i2 comprise “ [symbol] ”, etc. The Chinese character structure groups which are kept down and which are referred to in the point it and the point i2 are separate with other Chinese character structure(s), and as far as possible contain more said same or symmetry subordinate Chinese character structure(s); for instance, to keep down “ [symbol] ” of “ [symbol] ” rather than just to keep down “ [symbol] ”∘

When need, can take “the higher position part is first recording part, when the position is level, then the outside part of the turning line is first recording part” to replace the “the outside part of the turning line is first recording part, the inside part of the turning line is after recording part” in the item C, D and C3.

From the above examples, can get the rough stroke order of corresponding Chinese character; and recognize the stroke orders of Chinese character structures of the table of Chinese character stroke order special situation, can completely recognize the stroke order of corresponding Chinese character. Corresponding to different table of Chinese character set, for example, the <Table of Current Chinese Frequently-used Chinese Character> which contains 3,500 Chinese characters, the <Table of Current Chinese Commonly-used Chinese Character> which contains 7,000 Chinese characters, there are different tables of Chinese character stroke order special situation. Corresponding to different Chinese character stroke order regulation, for example, the Chinese character stroke order regulation of mainland China, the Chinese character stroke order regulation of Hong Kong, Macao, Taiwan, the Chinese character stroke order regulation of Japan, there are also different tables of Chinese character stroke order special situation.

Can set up rules to the table of Chinese character stroke order special situation, thus reduce the quantity of Chinese character structures which the table contains. For example, some Chinese character structures are after recording: 1. A Chinese character structure contains a “Oblique Hook” group structure (comprising the rest of the Chinese character structure which “ [symbol] ” is removed the stroke “ [symbol] ”; the rest of the Chinese character structure which “ [symbol] ” is removed the strokes “ [symbol] ” and “ [symbol] ”; the rest of the Chinese character structure which “ [symbol] ” is removed the stroke “ [symbol] ”; the formed Chinese character structure which “ [symbol] ” is added a “ [symbol] ” or two “ [symbol] ” near the stroke “ [symbol] ” and intersecting with Oblique Hook, after being removed “ [symbol] ”; etc.); obtain the “Oblique Hook” group structure, the Chinese character structure(s) which intersects (intersect) with the “Oblique Hook” group structure and the Chinese character structure(s) which is (are) contained in the interval(s) that they intersect and then divide out, as a Chinese character structure group, to integrally keep down (for instance, obtain “ [symbol] , [symbol] ”, to integrally keep down. For the Chinese character stroke order regulation of Japan, the Chinese character structure group can also not include the Chinese character structure which lies at the left edge of the interval, for instance, the stroke “ [symbol] ” of “ [symbol] ”.); when record the Chinese character structure group, the “Oblique Hook” group structure is after recording, for instance, the “Oblique Hook” group structure in “ [symbol] ” is recorded after having recorded “ [symbol] ”. 2. In the interval which the “beaded” structure or the “ [symbol] ” group structure divides out and which at the upper-right corner, it only contains a single stroke “ [symbol] ”, when record the “beaded” structure or the “ [symbol] ” group structure, the “ [symbol] ” is after recording (when the “ [symbol] ” belongs a part of “Oblique Hook” group structure, process it according to “Oblique Hook” group structure.), for instance, the “ [symbol] ” of “ [symbol] ” is after recording. 3. In the Chinese character structure which cannot be continued split according to the Chinese character stroke order quick recognition method, the stroke “Lift” which intersects with other Chinese character structure(s) is after recording (when the Chinese character structure also contains a “Oblique Hook” group structure, first removed the “Oblique Hook” group structure, namely the “Oblique Hook” group structure is recording later than the “Lift”.), for instance, the “Lift” of “ [symbol] ” is recorded after having recorded the Chinese character structure which intersect with it; the stroke “ [symbol] ” which intersects with other Chinese character structure(s) is after recording, for instance, the “ [symbol] ” of “ [symbol] ” is recorded after having recorded the Chinese character structure which intersect with it; the stroke “Right Slope” (displayed as FIG. 10) is after recording, for instance, the “Right Slope” of “ [symbol] ” is recorded after having recorded “ [symbol] ” . . . . For the Chinese character structures which contain the “Oblique Hook” group structure, “Lift”, “ [symbol] ” or “Right Slope”, can temporarily ignore the existence of the “Oblique Hook” group structure, “Lift”, “ [symbol] ” or “Right Slope” and continue to process according to Chinese character stroke order quick recognition method, and determine the recording orders, for instance, “ [symbol] ” can be temporarily ignored the existence of the “Oblique Hook” group structure and continued to split into “ [symbol] ”, record the “Oblique Hook” group structure at the last. And for example, can also set up a rule: after processing according to the point i1, when the Chinese character structure group which is kept down and which left and right are the same is composed of two character formation structures (namely Chinese character) left and right juxtaposed, process not according to the point it again when continue to split; for instance, “ [symbol] ” is composed of two character formation structures “ [symbol] ” left and right juxtaposed, first accord to the item C split when split, do not process according to the point i1.

For the different Chinese character stroke order regulation, can set up different rules to the table of Chinese character stroke order special situation. For the Chinese character stroke order regulation of Japan, when the like “ [symbol] ” group structure as FIG. 80 displayed (the Chinese character structure which 1 indicates in FIG. 80 can be a “ [symbol] ”, can also be two “ [symbol] ”; the Chinese character structure which 2 indicates can be a “ [symbol] ”, can also be two “ [symbol] ”; the “ [symbol] ” which 2 indicates is shorter than or equal to the “ [symbol] ” which 3 indicates; it is empty no strokes in the intervals which 4 and 5 indicate.) connects or intersects with the Chinese character structure(s) above it (this rule can further be defined as: when the like “ [symbol] ” group structure connects with any one Chinese character structure of “ [symbol] ”, “ [symbol] ” and the Chinese character structure displayed as FIG. 7 above it, or intersects with any one Chinese character structure of “ [symbol] ” above it.), integrally keep down this Chinese character structure group, the like “ [symbol] ” group structure is after recording when record this Chinese character structure group, and record according to the order displayed as the number signs with arrow in FIG. 80 (when 1 indicates two “ [symbol] ”, these two “ [symbol] ” are recorded according to first the left after the right; when 2 indicates two “ [symbol] ”, these two “ [symbol] ” are recorded according to first the above after the below.). So the orders of “ [symbol] ” respectively is: [symbol] , [symbol] , [symbol] , [symbol] , [symbol] , [symbol] , [symbol] , [symbol] ; [symbol] , [symbol] .

For the Chinese character stroke order regulation of mainland China, the like “ [symbol] ” structure refers to the stroke “ [symbol] ” which 1 indicates and which is divided into two sections by “ [symbol] ” that 2 indicates in FIG. 80, the ratio of its upper section and lower section is greater than 2, there is obvious difference with the Chinese character “ [symbol] ”; or refers to the “ [symbol] ” which 3 indicates is obviously too long, there is obvious difference with the Chinese character “ [symbol] ”, (the like “ [symbol] ” structure does not include the Chinese character structure displayed as the above part of the horizontal gap of “ [symbol] ”). So it contains like “ [symbol] ” structure in each Chinese character of “ [symbol] ”; it does not contain like “ [symbol] ” structure in each Chinese character of “ [symbol] ”. When the like “ [symbol] ” structure connects or intersects with the Chinese character structure(s) above it, integrally keep down this Chinese character structure group, the like “ [symbol] ” structure is after recording when record this Chinese character structure group, and record according to the order displayed as the number signs with arrow in FIG. 80.

For the Chinese character structures which contain the like “ [symbol] ” group structure or like “ [symbol] ” structure, can temporarily ignore the existence of like “ [symbol] ” group structure or like “ [symbol] ” structure and continue to process according to Chinese character stroke order quick recognition method, and determine the recording orders.

In Japan, besides the standard Chinese character stroke orders teaching in schools, there are other nonstandard Chinese character stroke orders. Similarly, can set up rules to the tables of Chinese character stroke order special situation which correspond to the nonstandard Chinese character stroke orders; for example, the stroke “ [symbol] ” which is located in the center position of the Chinese character structure and which runs through a plurality of strokes or most of the Chinese character structure is after recording when record the Chinese character structure (when this rule is incorporated in the point h2 of the supplementary description, need to indicate that this rule is prior to the other rules of the point h2.), for instance, the stroke “ [symbol] ” of “ [symbol] ” is recorded at the last.

In order to adapt to different Chinese character stroke order regulations, and achieve the best result, the rules which set up to the table of Chinese character stroke order special situation and the rules of the supplementary description of Chinese character stroke order quick recognition method can be transferred to each other. For example, in order to adapt to the Chinese character stroke order regulations of Japan, can take the rule which relates to like “ [symbol] ” group structure to enroll in the supplementary description of Chinese character stroke order quick recognition method.

When the used information recording appliance is a computer system which has been equipped with the hand input function and equipment, it can that use a light pen or finger to record according to stroke orders on the input screen. When the used information recording appliance is a computer system which has been equipped with a mouse, it can that use the mouse to record according to stroke orders on the input screen, or it can that use the mouse to click on the corresponding strokes which are displayed on the screen according to stroke orders; select a Chinese character in the coincident code Chinese characters which are displayed on the screen when the Chinese characters are coincident code. When the used information recording appliance is a computer system which has been equipped with a keyboard, it can that tap on the corresponding stroke-keys or the corresponding code-keys of the strokes according to the stroke orders on the keyboard; select a Chinese character in the coincident code Chinese characters which are displayed on the screen when the Chinese characters are coincident code.

### INDUSTRIAL APPLICABILITY

There are two situations when use an information recording appliance to record Chinese character information. The first situation is people whose mother tongue are recorded in Chinese characters, first take years time to learn Chinese knowledge and Chinese character information recording method, then have a job which relates to the Chinese character information recording by using an information recording appliance. The second situation is people whose mother tongue are not recorded in Chinese characters, when encounter the situation that there are some Chinese character information need to record in the work, to learn the Chinese character information recording method, then use an information recording appliance to record; if the work is important and plenty of, they will willingly take years time to learn Chinese character information recording method, if not, they will more willingly give up such work; such will delay the work.

The technical solution provided by the present application can help the Chinese character beginners who have never contact with Chinese characters (whether or not their mother tongues are recorded in Chinese characters) to realize to record Chinese character information smoothly according to Chinese character stroke orders by using an information recording appliance with relatively little difficulty and relatively short time.

1-21. (canceled)

22. A Chinese character information recording method, comprising: a step for recognizing Chinese character strokes, a step for recognizing Chinese character stroke orders, and a step for recording Chinese characters according to Chinese character stroke orders by using an information recording appliance; wherein said step for recognizing Chinese character stroke orders comprises a step for recognizing Chinese character stroke orders according to a Chinese character stroke order quick recognition method and a step for recognizing Chinese character stroke orders contrasting a table of Chinese character stroke order special situation;
wherein said Chinese character stroke order quick recognition method is described herein: contrast the following method from the first item to the last item, obtain a Chinese character structure to split into two parts according to the first suitable one; obtain the two parts which have been split to respectively contrast the following method from the first item to the last item, and split into two parts according to the first suitable one again; and so on, until cannot continue to split according to the following method:
A obtaining a vertical line to run through a vertical gap of a Chinese character structure, the left part of the vertical line is first recording part, the right part of the vertical line is after recording part; when there is no vertical gap which can be run through,
B obtaining a horizontal line to run through a horizontal gap of a Chinese character structure, the above part of the horizontal line is first recording part, the below part of the horizontal line is after recording part; when there is no horizontal gap which can be run through,
C obtaining a turning line to run through a turning gap of a Chinese character structure, the outside part of the turning line is first recording part, the inside part of the turning line is after recording part; when there is no turning gap which can be run through,
D obtaining a turning line to run through a turning potential gap of a Chinese character structure, the outside part of the turning line is first recording part, the inside part of the turning line is after recording part; when there is no turning potential gap which can be run through,
wherein said table of Chinese character stroke order special situation comprises the Chinese character structures which are processed according to Chinese character stroke order quick recognition method and which the got stroke orders are different from the standard stroke orders, and the basic Chinese character structures.

23. The Chinese character information recording method of claim 22, wherein the following Chinese character structures are after recording in the table of Chinese character stroke order special situation:
1 a Chinese character structure contains a “Oblique Hook” group structure; obtain the “Oblique Hook” group structure, the Chinese character structure(s) which intersects (intersect) with the “Oblique Hook” group structure and the Chinese character structure(s) which is (are) contained in the interval(s) that they intersect and then divide out, as a Chinese character structure group, to integrally keep down, when record the Chinese character structure group, the “Oblique Hook” group structure is after recording;
2 the stroke “Lift” which intersects with other Chinese character structure(s) is after recording;
3 the stroke “ [symbol] ” which intersects with other Chinese character structure(s) is after recording;
4 the stroke “Right Slope” is after recording;
5 for the Chinese character stroke order regulation of Japan, when the like “ [symbol] ” group structure connects or intersects with the Chinese character structure(s) above it, integrally keep down this Chinese character structure group, the like “ [symbol] ” group structure is after recording when record this Chinese character structure group;
6 for the Chinese character stroke order regulation of mainland China, when the like “ [symbol] ” structure connects or intersects with the Chinese character structure(s) above it, integrally keep down this Chinese character structure group, the like “ [symbol] ” structure is after recording when record this Chinese character structure group;
wherein for the Chinese character structures which contain the “Oblique Hook” group structure, “Lift”, “ [symbol] ”, “Right Slope”, like “ [symbol] ” group structure or like “ [symbol] ” structure, temporarily ignore the existence of “Oblique Hook” group structure, “Lift”, “ [symbol] ”, “Right Slope”, like “ [symbol] ” group structure or like “ [symbol] ” structure and continue to process according to Chinese character stroke order quick recognition method, and determine the recording orders.

24. The Chinese character information recording method of claim 23, wherein an item E is increased behind the item D in the Chinese character stroke order quick recognition method, wherein the item E is: obtaining a horizontal line to run through a horizontal potential gap of a Chinese character structure, the above part of the horizontal line is first recording part, the below part of the horizontal line is after recording part; when there is no horizontal potential gap which can be run through.

25. The Chinese character information recording method of claim 23, wherein an item C2 is increased behind the item C and closing to the item C in the Chinese character stroke order quick recognition method, wherein the item C2 is: obtaining a horizontal line to run through a horizontal potential gap of a Chinese character structure, the above part of the horizontal line is first recording part, the below part of the horizontal line is after recording part; when there is no horizontal potential gap which can be run through.

26. The Chinese character information recording method of claim 23, wherein an item B2 is increased behind the item B and closing to the item B in the Chinese character stroke order quick recognition method, wherein the item B2 is: obtaining a horizontal line to run through a horizontal potential gap of a Chinese character structure, the above part of the horizontal line is first recording part, the below part of the horizontal line is after recording part; when there is no horizontal potential gap which can be run through.

27. The Chinese character information recording method of claim 23, wherein an item A2 is increased behind the item A and closing to the item A in the Chinese character stroke order quick recognition method, wherein the item A2 is: obtaining a horizontal line to run through a horizontal potential gap of a Chinese character structure, the above part of the horizontal line is first recording part, the below part of the horizontal line is after recording part; when there is no horizontal potential gap which can be run through.

28. The Chinese character information recording method of claim 24, wherein an item F is increased behind the last item in the Chinese character stroke order quick recognition method, wherein the item F is: obtaining a vertical line to run through a vertical potential gap of a Chinese character structure, the left part of the vertical line is first recording part, the right part of the vertical line is after recording part.

29. The Chinese character information recording method of claim 25, wherein an item F is increased behind the last item in the Chinese character stroke order quick recognition method, wherein the item F is: obtaining a vertical line to run through a vertical potential gap of a Chinese character structure, the left part of the vertical line is first recording part, the right part of the vertical line is after recording part.

30. The Chinese character information recording method of claim 26, wherein an item F is increased behind the last item in the Chinese character stroke order quick recognition method, wherein the item F is: obtaining a vertical line to run through a vertical potential gap of a Chinese character structure, the left part of the vertical line is first recording part, the right part of the vertical line is after recording part.

31. The Chinese character information recording method of claim 27, wherein an item F is increased behind the last item in the Chinese character stroke order quick recognition method, wherein the item F is: obtaining a vertical line to run through a vertical potential gap of a Chinese character structure, the left part of the vertical line is first recording part, the right part of the vertical line is after recording part.

32. The Chinese character information recording method of claim 25, wherein an item C4 is increased before the item D and closing to the item D in the Chinese character stroke order quick recognition method, wherein the item C4 is: obtaining a vertical line to run through a vertical potential gap of a Chinese character structure, the left part of the vertical line is first recording part, the right part of the vertical line is after recording part; when there is no vertical potential gap which can be run through.

33. The Chinese character information recording method of claim 26, wherein an item C4 is increased before the item D and closing to the item D in the Chinese character stroke order quick recognition method, wherein the item C4 is: obtaining a vertical line to run through a vertical potential gap of a Chinese character structure, the left part of the vertical line is first recording part, the right part of the vertical line is after recording part; when there is no vertical potential gap which can be run through.

34. The Chinese character information recording method of claim 27, wherein an item C4 is increased before the item D and closing to the item D in the Chinese character stroke order quick recognition method, wherein the item C4 is: obtaining a vertical line to run through a vertical potential gap of a Chinese character structure, the left part of the vertical line is first recording part, the right part of the vertical line is after recording part; when there is no vertical potential gap which can be run through.

35. The Chinese character information recording method of claim 26, wherein an item B4 is increased before the item C and closing to the item C in the Chinese character stroke order quick recognition method, wherein the item B4 is: obtaining a vertical line to run through a vertical potential gap of a Chinese character structure, the left part of the vertical line is first recording part, the right part of the vertical line is after recording part; when there is no vertical potential gap which can be run through.

36. The Chinese character information recording method of claim 27, wherein an item B4 is increased before the item C and closing to the item C in the Chinese character stroke order quick recognition method, wherein the item B4 is: obtaining a vertical line to run through a vertical potential gap of a Chinese character structure, the left part of the vertical line is first recording part, the right part of the vertical line is after recording part; when there is no vertical potential gap which can be run through.

37. The Chinese character information recording method of claim 22, wherein said information recording appliance is a computer system which has been equipped with the Chinese character input function and equipment.

38. The Chinese character information recording method of claim 23, wherein said information recording appliance is a computer system which has been equipped with the Chinese character input function and equipment.

39. The Chinese character information recording method of claim 24, wherein said information recording appliance is a computer system which has been equipped with the Chinese character input function and equipment.

40. The Chinese character information recording method of claim 25, wherein said information recording appliance is a computer system which has been equipped with the Chinese character input function and equipment.

41. A Chinese character stroke order recognition diagram prepared by the steps of: splitting a Chinese character structure according to the Chinese character stroke order quick recognition method referred to in any one of claims 22 to 36; marking out the vertical line(s), the horizontal line(s), the turning line(s) which is (are) involved in the split process and the split order in the Chinese character structure.
